(19) United States
(12) Patent Application Publication
(10) Pub. No.: US 2020/0403340 A1
(43) Pub. Date: Dec. 24, 2020

(54) WATER REPELLENT AGENT, WATER-REPELLENT TREATED MATERIAL, ELECTRICAL CONNECTION STRUCTURE, AND WIRE HARNESS

(71) Applicants: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP); KYUSHU UNIVERSITY, NATIONAL UNIVERSITY CORPORATION, Fukuoka-shi (JP)

(72) Inventors: Naoyuki OSHIUMI, Yokkaichi-shi (JP); Takehiro HOSOKAWA, Yokkaichi-shi (JP); Makoto MIZOGUCHI, Fukuoka-shi (JP)

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP); KYUSHU UNIVERSITY, NATIONAL UNIVERSITY CORPORATION, Fukuoka-shi (JP)

(21) Appl. No.: 16/892,455

(22) Filed: Jun. 4, 2020

(30) Foreign Application Priority Data
Jun. 20, 2019 (JP) 2019-114816

(51) Int. Cl. H01R 13/03; H01R 13/533; H01B 7/00; C08L 33/12; C08L 25/10; C08L 27/06; C08L 69/00; C08L 23/26; C08L 25/06

(52) U.S. Cl. CPC H01R 13/03; H01R 13/533; H01B 7/0045; C08L 33/12; C08L 2207/04; C08L 27/06; C08L 69/00; C08L 23/26; C08L 25/06; C08L 25/10

(57) ABSTRACT

A water repellent agent is provided that can easily form a water repellent layer that shows high water repellency and has high thermal resistance even without a material containing fluorine atoms, as well as a water-repellent treated material, an electrical connection structure, and a wire harness which have water repellent layers formed of the water repellent agent. The water repellent agent contains hydrophobized silica particles as component A, a resin having a glass transition temperature of 100° C. or higher as component B, an acid-modified resin as component C, and an organic solvent as component D. The water repellent agent has a mass ratio B:C of the component B and the component C in the range of 95:5 to 50:50.

### TECHNICAL FIELD

The present disclosure relates to a water repellent agent, a water-repellent treated material, an electrical connection structure, and a wire harness.

### BACKGROUND ART

In a member that may be affected by prolonged contact with water or an electrolyte, water repellent treatment may sometimes be applied to a surface. By water repellent treatment applied to the surface of the member with a water repellent agent, water or the electrolyte hardly remains on the surface of the member for a long period of time even when water or an electrolyte comes in contact with the surface of the member, and thus the influence caused by prolonged contact with the water or the electrolyte can be reduced.

As such kinds of water repellent agents, those containing materials containing fluorine atoms are known. Materials containing fluorine atoms are excellent in the effect of reducing the surface energy of the water repellent agents and give high water repellency. Water repellent agents which contain materials containing fluorine atoms are disclosed in Patent Literatures 1 to 5 below, for example. In Patent Literatures 1 to 3, chemical compounds each containing a plurality of fluorine atoms are contained in water repellent agents. In Patent Literatures 4 and 5, water repellent agents contain fluororesin-based particles.

Further, fluorine-free water repellent agents, which do not contain fluorine atoms, are also known. Since many fluorine-free water repellent agents can not use the effect of reducing the surface energy which can be brought about by materials containing fluorine atoms, the fluorine-free water repellent agents exhibit water repellency by giving fine roughness to surfaces to be treated and thus by increasing water contact angles on the surfaces due to the roughness. Such kinds of fluorine-free water repellent agents are disclosed in Patent Literatures 6 to 10 below, for example. Patent Literatures 6 to 10 disclose water repellent agents which contain polymerizable compounds. Through polymerization, water repellent film structures are formed on surfaces to be treated. Rough structures are given to the surfaces by the polymerizable compound itself in Patent Literature 6 and by fine particles mixed with the polymerizable compounds in Patent Literatures 7 to 10.

### CITATION LIST

### Patent Literature

PTL1: JP 2016-204463 A

PTL2: JP 2015-187220 A

PTL3: JP 2009-263486 A

PTL4: JP 2011-140625 A

PTL5: JP 2016-166308 A

PTL6: JP 2017-066325 A

PTL7: JP 2008-101197 A

PTL8: JP 2002-114941 A

PTL9: JP 2010-121021 A

PTL10: JP 2018-135469 A

### SUMMARY OF INVENTION

### Technical Problem

As stated above, a water repellent agent excellent in water repellency can be prepared with a material containing fluorine atoms, but a material containing fluorine atoms may possibly affect the environment. Meanwhile, in a fluorine-free water repellent agent, it is often necessary to undergo a reaction process such as a polymerization reaction after applied in a liquid state in order to forma stable water repellent layer having a rough structure on a surface to be treated by the water repellent agent (hereinafter referred to as a target surface), which makes the process of water repellent treatment complicated. Further, a polymer formed through polymerization reaction after the water repellent agent is applied is often easy to be deformed at a high temperature, Further, a polymer formed through polymerization reaction after the application of the water repellent agent is often easy to be deformed at a high temperature, and it is difficult to increase the thermal resistance of the water repellent layer.

An object of the present invention therefore is to provide: a water repellent agent that can easily form a water repellent layer that shows high water repellency and has high thermal resistance even without a material containing fluorine atoms; and a water-repellent treated material, an electrical connection structure, and a wire harness which have water repellent layers formed of the water repellent agent.

### Solution to Problem

A water repellent agent according to the present disclosure contains hydrophobized silica particles as component A, a resin having a glass transition temperature of 100° C. or higher as component B, an acid-modified resin as component C, and an organic solvent as component D. The water repellent agent has a mass ratio B:C of the component B and the component C in the range of 95:5 to 50:50.

### Advantageous Effects of Invention

A water repellent agent according to the present disclosure can easily form a water repellent layer that shows high water repellency and has high thermal resistance even without a material containing fluorine atoms.

### BRIEF DESCRIPTION OF DRAWINGS

FIG. 1 is a sectional view explaining a configuration of a surface of a water-repellent treated material according to an embodiment of the present disclosure.

FIG. 2 is a sectional view showing an outline of a connector as an example of an electrical connection structure according to an embodiment of the present disclosure.

FIG. 3 is a side view showing an outline of a wire harness according to an embodiment of the present disclosure.

### DESCRIPTION OF EMBODIMENTS

### Explanation of Embodiments According to Present Disclosure

First, embodiments according to the present disclosure will be listed and explained. A water repellent agent according to the present disclosure has hydrophobized silica particles as component A, a resin having a glass transition temperature of 100° C. or higher as component B, an acid-modified resin as component C, and an organic solvent as component D. The water repellent agent has a mass ratio B:C of the component B and the component C in the range of 95:5 to 50:50.

The water repellent agent can form a water repellent layer by being applied to a target surface through coating or the like. The water repellent layer is fixed to the target surface in a state where hydrophobized silica particles as the component A are dispersed in a resin film containing the component B and the component C, which are resin materials. The water repellent layer shows high water repellency by the hydrophobized silica particles forming fine roughness at a surface of the water repellent layer. The resin materials are dispersed or dissolved in the organic solvent as the component D and contained in the water repellent agent already in a polymerized form, and thus the materials can forma solid water repellent layer just through evaporation of the organic solvent without undergoing a chemical reaction such as polymerization. Therefore, water repellent treatment can be applied easily to a target surface with the water repellent agent.

Further, containing the component B having the high glass transition temperature as a resin material, the water repellent agent can retain high thermal resistance, whereby a state where silica particles are dispersed in the water repellent layer to be formed and fixed to the target surface stably even at a high temperature. Moreover, since the water repellent agent contains the acid-modified resin as the component C together with the component B, it is possible to enhance the adhesiveness of the water repellent layer to the target surface. Having the mass ratio B:C of the component B and the component C within the range of 95:5 to 50:50 in the water repellent agent, the water repellent layer to be formed can have both high thermal resistance and adhesiveness. Thus, containing the component B and the component C at the specific ratio in addition to the component A and the component D, the water repellent agent can easily form a water repellent layer that shows high water repellency and thermal resistance and also is excellent in adhesiveness to the target surface even without a material containing fluorine atoms.

Here, the component C may desirably contain an acid-modified elastomer. Then, the water repellent layer formed of the water repellent agent shows particularly high adhesiveness to the target surface by the softness of the component C.

The component C may desirably be a maleic acid-modified resin. A maleic acid-modified resin is relatively easy to be obtained among acid-modified resins and gives high adhesiveness to the water repellent agent.

Silica particles constituting the component A may desirably have an average particle size of 100 nm or smaller. Then, the silica particles are fixed stably to the target surface in the water repellent layer, and a state showing high water repellency is effectively retained.

A content of the component A may desirably be 0.1% or more and 10% or less by mass. By containing the sufficient amount of the component A in the water repellent agent, reliable water repellent effect is effectively exhibited. Further, by not containing an excessive amount of the component A, it is possible to suppress the viscosity of the water repellent agent and reduce the material costs of the water repellent agent.

A mass ratio A:(B+C) between the component A and a sum of the component B and component C may desirably be in the range of 90:10 to 30:70. Then, since the water repellent agent contains the silica particles as the component A in the sufficient amount with respect to the resin component, sufficient roughness is formed at the surface of the water repellent layer formed of the water repellent agent, and high water repellency is exhibited. On the other hand, since the water repellent agent does not contain an excessive amount of the silica particles as the component A with respect to the resin component, the silica particles do not fall off from the water repellent layer, the silica particles stably remain in the state fixed to the target surface by the resin material.

The water repellent agent may desirably not contain a material containing fluorine atoms. The water repellent agent can form a water repellent layer having sufficiently high water repellency on the target surface by having the above-described specific component composition, in particular by containing hydrophobized silica particles as the component A, even when a material containing fluorine atoms is not contained. By not containing a material containing fluorine atoms, the water repellent agent has less impact on the environment.

The water repellent agent may desirably not contain an alkoxysilane. An alkoxysilane can function as a silane coupling agent, and firmly fix the silica particles as the component A to the target surface through a reaction between a silanol group and a hydroxyl group. In the water repellent agent, however, the silica particles can be fixed sufficiently firmly to the target surface by the resin materials as the components B and C. Hence it is not necessary to contain an alkoxysilane, and it is possible to easily apply the water repellent treatment without a complicated process as in the case of forming a chemical bond using an alkoxysilane.

The organic solvent as the component D may desirably has a boiling point of 150° C. or lower. Then, it is possible to evaporate the organic solvent as the component D at a relatively low temperature or in a short period of time after the water repellent agent is applied to a target surface by coating or the like, and hence convenience in water repellent treatment improves.

A water-repellent treated material according to the present disclosure has a base material and a water repellent layer formed of the above-described water repellent agent covering a surface of the base material. Thus, even when the water repellent agent does not contain a material containing fluorine atoms, it is possible to form a water repellent layer having high water repellency to produce a water-repellent treated material where the surface of the base material is treated with the water repellent treatment. Further, the water repellent layer having high thermal resistance can be formed easily.

Here, in the water repellent layer, the component D may desirably have been evaporated. By evaporating the component D that has dispersed or dissolved the resin materials as the components B and C, a state where the water repellent layer adheres stably to the surface of the base material is formed easily.

The base material may desirably contains a resin or metal material at a surface thereof. By containing the component B and the component C as the resin materials, the water repellent agent can form the water repellent layer with high adhesiveness on the surface of the base material of various materials including a resin material and a metal material.

An electrical connection structure according to the present disclosure contains the water-repellent treated material described above and can form electrical connection with another electrical connection member. In an electrical connection structure, electrical connection characteristics may be influenced if water or an electrolyte is kept in contact with a surface of the electrical connection structure or held inside the structure. However, a water repellent layer formed of the above-described water repellent agent, which has high water repellency, on the surface of the electrical connection structure makes the water and the electrolyte hard to be held inside, and suppresses their influence. Further, though the temperature of the electrical connection structure tends to rise upon application of electric current, the water repellent layer, having high thermal resistance, can maintain the state of exhibiting such high water repellency even after subjected to high temperature environment.

Here, the electrical connection structure may desirably be configured as a connector containing a connecting terminal containing a metal material at a surface thereof and a connector housing accommodating the connecting terminal and containing a resin material at a surface thereof. The connector contains the water repellent layer on at least one selected from the group consisting of the surface of the metal material of the connecting terminal and the surface of the resin material of the connector housing. Then, even when water or an electrolyte is in contact with the connector housing or the connecting terminal, the water or electrolyte is difficult to stay in the contact state. The water repellent layer thus suppresses corrosion due to the prolonged contact with water or an electrolyte of the metal material constituting the connecting terminal and subsequent influence on the electrical connection characteristics of the connector.

A wire harness according to the present disclosure contains the electrical connection structure described above. Since an electrical connection structure contained in the wire harness such as a terminal connector is treated with the above-described water repellent agent, the electrical connection structure has high water repellency and is possible to minimize influences such as corrosion of a metal material in the structure even in contact with water or an electrolyte. Further, since the water repellent layer has high thermal resistance, the high water repellency is effectively retained even when the electrical connection structure of the wire harness is placed in a high temperature environment. The wire harness therefore can be used suitably for applications where contact with water or an electrolyte and high temperature environment are assumed such as in an automobile.

### Details of Embodiments According to Present Disclosure

Embodiments according to the present disclosure are hereunder explained in reference to the drawings. A water-repellent treated material and an electrical connection structure according to embodiments of the present disclosure can be formed by using a water repellent agent according to an embodiment of the present disclosure. Further, a wire harness according to an embodiment of the present disclosure can be configured including the electrical connection structure.

### <Water Repellent Agent>

First, a water repellent agent according to an embodiment of the present disclosure is explained. A water repellent agent according to an embodiment of the present disclosure is configured as a composition containing the following components A to D.

Component A: hydrophobized silica particles

Component B: a resin having a glass transition temperature of 100° C. or higher

Component C: an acid-modified resin

Component D: an organic solvent

A mass ratio B:C of the component B and the component C is in the range of 95:5 to 50:50. Here, the range of the mass ratio includes the upper end value and the lower end value of the mass ratio; hereinafter, the same applies to the description of ratios in the present specification.

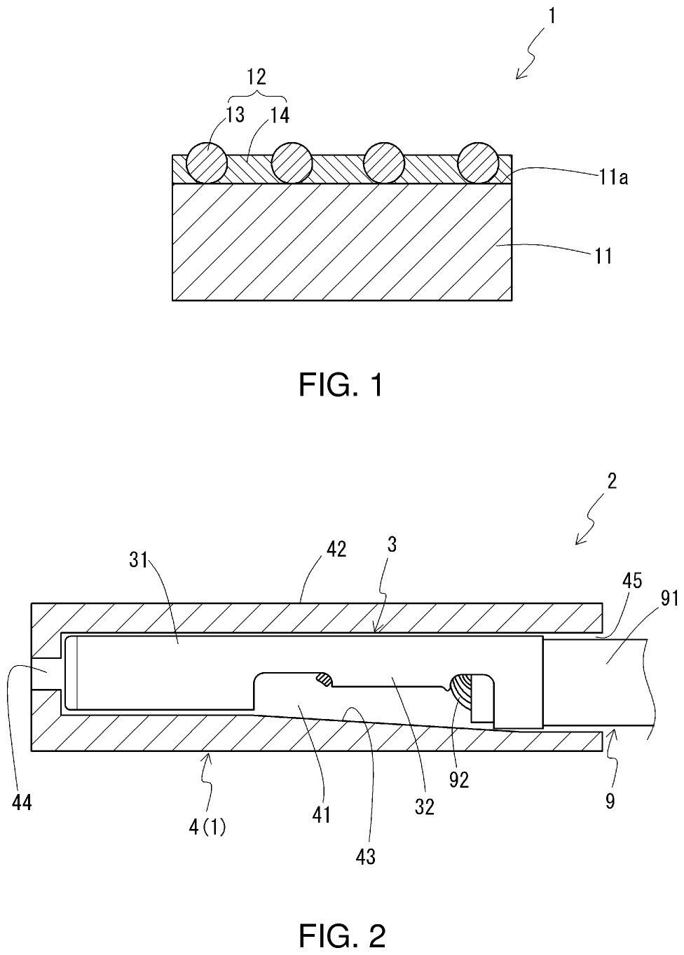

By applying the water repellent agent containing the components A to D to a target surface by coating or the like, a water repellent layer having water repellency can be formed on the target surface after the organic solvent as the component D is removed by evaporation or the like. In the water repellent layer, the silica particles as the component A is dispersed in a film structure of a mixture of the component B and the component C, which are resin materials (see FIG. 1). The respective components are explained hereunder.

### (a) Component A: Hydrophobized Silica Particles

The component A is a component to give water repellency to a water repellent agent. Because the silica particles are hydrophobized, the silica particles themselves or a water repellent agent containing the silica particles show/shows water repellency. Further, when a water repellent layer is formed on a target surface by using the water repellent agent, fine roughness derived from the particle shapes of the silica particles is formed at a surface of the water repellent layer (see FIG. 1). By the existence of the rough structure, the contact angle of water on the surface of the water repellent layer increases, and the water repellency of the water repellent layer surface is enhanced. That is, because the silica particles not only are hydrophobized but also form a rough structure, water repellency is exhibited.

The surfaces of the silica particles may be hydrophobized through binding of a hydrophobic functional group such as a hydrocarbon group to the surfaces of the silica particles. Examples of the hydrophobic functional group include alkyl groups such as a methyl group, an ethyl group, a propyl group, a butyl group, and an octyl group. To introduce such a hydrophobic functional group onto the surfaces of the silica particles, for example, silica particles are prepared as wet silica, and the surface of the hydrophilic silica (hydroxyl bonded silica) is chemically processed with a hydrophobizing agent such as silane or siloxane. Examples of the hydrophobizing agent include an organosilicon compound having the alkyl group as described above. Specific examples of the hydrophobizing agent include alkoxysilanes such as methyltrimethoxysilane, dimethyldimethoxysilane, and trimethylmethoxysilane; chlorosilanes such as trimethylchlorosilane; and silazane compounds such as hexamethyldisilazane and tetramethyldisilazane. Among those chemical compounds, it is desirable in particular to use an organosilicon compound having trimethyl group(s) such as trimethylmethoxysilane or hexamethyldisilazane from the viewpoint of giving high hydrophobicity to silica particles. The hydrophobizing agent may be used alone or in combination of two or more.

Silica particles may also contain a chemical compound other than silica in the particles or may have a surface treatment structure derived from a chemical compound other than the hydrophobizing agent as described above on the surfaces. It is desirable, however, that silica particles do not contain fluorine atoms or a chemical compound containing fluorine atoms in the structure of the particle or the surface treatment agent.

A particle size of the silica particles is not particularly limited but is desirably 100 nm or smaller, more desirably 80 nm or smaller, and yet more desirably 50 nm or smaller in terms of an average particle size (D50). Having the particle size at the above-stated values or smaller, the silica particles stably form and maintain a state where the particles are fixed to the target surface. In particular, even when the smoothness of the target surface is low or the target surface has a complicated shape, silica particles can enter and stably stay in a non-smooth structure or a site constituting a narrow gap on the target surface. The water repellency of the water repellent layer therefore is effectively retained for a long period of time. When the particle size of the silica particles is too large, the silica particles hardly enter into the rough structure or the narrow space on the target surface and are likely to stay on the surface of a water repellent layer. As a result, when a physical load such as friction is applied to the surface of the water repellent layer, the silica particles are likely to peel off. By keeping the particle size of the silica particles as small as the above-stated upper limits or smaller, it is possible to inhibit such a phenomenon and stably retain water repellency. The lower limit of the particle size of silica particles is not particularly limited from the viewpoint of sufficiently giving and retaining water repellency; however, the average particle size is desirably 3 nm or larger from the viewpoint of availability and ease in handling.

A content of the component A in the water repellent agent is not particularly limited as well; however, from the viewpoint of making it easy to exhibit high water repellency, the content is desirably 0.1% or more by mass and more desirably 1.0% or more by mass on the basis of the total mass of all the constituent components of the water repellent agent. In contrast, from the viewpoint of keeping the viscosity of the water repellent agent low and improving its workability in water repellent treatment by coating or the like, and from the viewpoint of reducing material costs of the water repellent agent, the content of the component A in the water repellent agent is desirably 10% or less by mass and more desirably 7% or less by mass.

Further, the component A is contained in the water repellent agent at a rate of desirably 30:70 or higher and more desirably 40:60 or higher in terms of a mass ratio (A:(B+C)) to the sum of the component B and the component C. Containing a sufficiently large amount of the component A, the water repellent agent tends to have high water repellency. Further, when the water repellent agent contains a sufficiently large amount of the component A, the particles as the component A are not buried inside the resin film of the component B and the component C and effectively form a rough structure at the surface of the water repellent layer formed on the target surface, which also contributes to the effective enhancement of water repellency. Meanwhile, the content of the component A in the water repellent agent is controlled to a ratio of desirably 90:10 or lower and more desirably 80:20 or lower in terms of the content ratio (A:(B+C)). When the water repellent agent does not contain a large amount of the component A, the material costs of the water repellent agent can be reduced. Further, in the water repellent layer formed on the target surface, the particles as the component A are firmly fixed by the resin film formed of the component B and the component C and hardly fall off from the water repellent layer, whereby water repellency is effectively retained for a long period of time. Here, with regard to the content ratio of the component A to the sum of the component B and the component C, since the ratio in the water repellent agent is substantially retained also in a water repellent layer formed through evaporation of the organic solvent, it is desirable that the component A is contained at the above content ratio also in the formed water repellent layer. Hereinafter, in the present description, hydrophobized silica particles as the component A are referred to merely as silica particles.

### (b) Component B: Resin Having Glass Transition Temperature of 100° C. or Higher

The component B is a polymer material having a glass transition temperature (Tg) of 100° C. or higher. A glass transition temperature can be evaluated in accordance with JIS K7121 for example.

A polymer material has better thermal resistance as the polymer material has a higher glass transition temperature, and is more hardly softened, retaining an original shape even when the polymer material is heated to a high temperature. Since the component B has a glass transition temperature of 100° C. or higher, the water repellent agent is excellent in thermal resistance. That is, even when the water repellent layer formed of the water repellent agent is placed in a high temperature environment at or close to 100° C., the structure of the water repellent layer in which the particles as the component A are dispersed in the resin film formed of the resin material is held stably. As a result, fine roughness formed at the surface of the water repellent layer by the component A is held stably even in a high temperature environment, whereby high water repellency given by the component A can be retained stably even after the layer is subjected to the high temperature environment.

Specific examples of the resin having a glass transition temperature of 100° C. or higher that can be used suitably as the component B include polyacrylic resins such as methyl methacrylate polymer (PMMA); and engineering plastics such as polystyrene (PS), polycarbonate (PC), polyetheretherketone (PEEK), and polysulfone (PSU). In particular, from the viewpoint of securing dispersibility in an organic solvent, PMMA, PS, or PC is preferably used. Among them, PC can be most preferably used. The resin having a glass transition temperature of 100° C. or higher may be used as the component B alone or in combination of two or more. The component B is not acid-modified, unlike the component C explained next.

### (c) Component C: Acid-Modified Resin

The component C is an acid-modified resin. The acid-modified resin is a polymer graft modified with acid molecules such as carboxylic acid.

Since the water repellent agent contains the acid-modified resin, the water repellent layer exhibits increased adhesiveness to the target surface when the water repellent layer is formed on the target surface. Further, the stability in fixing silica particles as the component A to a target surface is increased. The reason is that, in addition to intrinsic interfacial chemical bonding force, hydrogen bonding force or ionic bonding force is increased by acid modification of the component C. Furthermore, when a reactive substituent group exists at a target surface, the adhesiveness of a water repellent layer and the stability in fixing silica particles are further enhanced by chemical bonding between the substituent group and an acid-modified group. By formation of the water repellent layer having high adhesiveness, a state where the water repellent layer covers a target surface and a state where silica particles are fixed to a target surface are maintained stably, whereby high water repellency is stably maintained even when the water repellent layer receives a physical load such as friction.

The type of acid-modification in the acid-modified resin is not particularly limited, but a maleic acid-modified resin is preferable. The reason is that the maleic acid-modified resin exhibits a noticeable effect in improving the adhesiveness of the water repellent layer and also is relatively easily available.

The kind of a polymer constituting the acid-modified resin is not particularly limited either, and an acid-modified thermoplastic resin, or an acid-modified elastomer can preferably be used as the component C. Examples of the acid-modified thermoplastic resin include acid-modified polyolefins such as maleic acid-modified (hereunder described as MAH-) polyethylene (MAH-PE) and MAH-polypropylene (MAH-PP); and MAH-polystyrene (MAH-PS). Examples of the acid-modified elastomer include acid-modified thermoplastic elastomers such as a styrene-based thermoplastic elastomer including a styrene/butadiene/styrene elastomer (SBS) and a styrene/ethylene/butylene/styrene elastomer (SEBS) (MAH-SBS, MAH-SEBS, etc.). An elastomer means a polymer having a hard segment and a soft segment. The acid-modified resins constituting the component C may be used alone or in combination of two or more.

Among those polymers, an acid-modified elastomer, such as MAH-SBS or MAH-SEBS, is particularly preferably used as the component C. The reason is that the elastomer is a polymer having a low elastic modulus and a high flexibility and hence is particularly good in the effect of enhancing the adhesiveness of the water repellent agent in addition to the effect of being acid-modified. Since apolymer having a low glass transition temperature tends to have high flexibility, it is desirable to use a polymer having a lower glass transition temperature such as the elastomer as the acid-modified resin constituting the component C from the viewpoint of enhancing the adhesiveness of the water repellent agent. Also in the case of using an acid-modified thermoplastic resin such as MAH-polyolefin or MAH-PS, a polymer having a lower glass transition temperature such as MAH-polyolefin has better effect of improving adhesiveness than a polymer having a higher glass transition temperature such as MAH-PS. The component C is desirably a polymer having a glass transition temperature lower than the component B and moreover having a glass transition temperature of 50° C. or lower or 20° C. or lower. An acid-modified elastomer such as MAH-SBS or MAH-SEBS is suitable for constituting the water repellent agent not only in adhesiveness but also in excellence in dispersibility in an organic solvent used as the component D.

As described above, the water repellent agent according to the present embodiment contains the resin of a high glass transition temperature as the component B and the acid-modified resin as the component C as the resin components, and the components B and C contribute to the improvement of the thermal resistance and the adhesiveness of the water repellent agent, respectively. A blend ratio of the component B and the component C is from 95:5 to 50:50 in a mass ratio B:C. By adopting such a blend ratio, a water repellent agent tends to have both the thermal resistance and the adhesiveness. When the component B is contained in excess of the above range, because of the shortage of the component C, adhesiveness is insufficient, and peeling-off of a water repellent layer from a target surface and falling-off of silica particles as the component A are likely to occur when a physical load such as friction is applied. Meanwhile, when the component C is contained in excess of the above range, because of the shortage of the component B, thermal resistance is insufficient, and a state where silica particles as the component A are dispersed and fixed in a water repellent layer and fine roughness is formed at the surface of the water repellent layer is hardly retained under a high temperature. A concentration of the components B and C in the water repellent agent may be selected appropriately so that a sufficient thickness of a water repellent layer may be formed or the components B and C may sufficiently be dispersed or dissolved in an organic solvent. The concentration, for example, may be decided desirably so that a sum (B+C) of the component B and the component C may be 0.005% or more and 30% or less by mass in the total mass of the water repellent agent.

### (d) Component D: Organic Solvent

The water repellent agent contains an organic solvent as the component D in addition to the components A to C. The organic solvent is not particularly limited to a specific kind as long as the organic solvent can disperse hydrophobized silica particles as the component A and can disperse or dissolve the component B and the component C that are resin components. Examples of a suitable organic solvent include tetrahydrofuran (THF), butyl acetate, toluene, ethyl acetate, isopropanol, methyl ethyl ketone, methyl isobutyl ketone, and xylene.

By dispersing or dissolving the components A to C in an organic solvent and preparing a water repellent agent in a state of having fluidity such as a liquid, it is possible to form a film of the water repellent agent on a target surface by coating or the like and thus to obtain a water repellent layer of a solid state after evaporation of the organic solvent. From the viewpoint of evaporating the organic solvent at a low temperature in a short period of time, a boiling point of the component D is desirably 150° C. or lower and further desirably 100° C. or lower. Further, from the viewpoint of enhancing the dispersibility of silica particles as the component A, the solubility parameter (SP value) of the organic solvent is desirably 10 or smaller.

### (e) Other Components

The water repellent agent may also contain components other than the components A to D, in addition to the components A to D as long as the characteristics given by the components A to D are not impaired remarkably. Examples of such components are various additives including a dispersant, a thickener, an inorganic filler, a pigment, a surfactant, a pH adjuster, a film formation aid, a leveling agent, a defoamer, an antioxidant, a UV absorber, a corrosion inhibitor, a colorant, a preservative, a disinfectant, an antistatic agent, a glossing agent, and a fungicide.

Further, the water repellent agent may contain a particulate material other than the component A and a resin material other than the component B and the component C. In order not to impair the characteristics given by the components A to C, however, a ratio of the component A in the particulate materials and a ratio of a sum of the component B and the component C in the resin materials are desirably be controlled to 50% or higher by mass.

As described here, the water repellent agent according to the present embodiment may contain a component other than the components A to D, but desirably does not contain a material containing fluorine atoms as a part of the components A to D or as a component other than the components A to D. A material containing fluorine atoms gives high water repellency as disclosed in Patent Literatures 1 to 5, but the water repellent agent according to the present embodiment contains hydrophobized silica particles as the component A and hence can exhibit sufficiently high water repellency even without a material containing fluorine atoms. From the viewpoint of eliminating an environmental burden caused by a material containing fluorine atoms, it is desirable that the water repellent agent does not contain a material containing fluorine atoms.

Further, the water repellent agent according to the present embodiment desirably does not contain an alkoxysilane. As shown in Patent Literatures 3, 9, and 10, if a water repellent agent containing silica particles contains an alkoxysilane, it is possible to bond the silica particles firmly to a target surface through the alkoxysilane after reaction between a silanol group and a hydroxyl group. The water repellent agent according to the present embodiment, however, contains the component B and the component C which include resin materials, and the resin materials play the role of fixing the silica particles of the component A firmly to a target surface and hence it is not necessary for the water repellent agent to contain an alkoxysilane and fix silica particles through chemical reaction. If silica particles are fixed via an alkoxysilane, a chemical reaction is required for fixation, and thus time and labor are required for forming a water repellent layer. Further, a target surface is required to be made of a material having a hydroxyl group on the surface such as glass or a metal compound in order to bond the silica particles via an alkoxysilane, but since the water repellent agent according to the present embodiment fixes silica particles to the target surface by the resin components, the material of the target surface is not limited. It is therefore possible to form a water repellent layer in which silica particles are fixed firmly to a target surface made of various materials such as a resin material.

Moreover, a water repellent agent according to the present embodiment desirably does not contain a component requiring chemical reaction, other than an alkoxysilane, for solidifying itself or for fixing or solidifying another component on a target surface. Examples of such a component other than an alkoxysilane include a polymerizable compound that is to be contained in the water repellent layer in the form of a polymer through a polymerization reaction (curing reaction), like those contained in the water repellent agents in Patent Literatures 6 to 10. When the water repellent agent does not contain a chemical compound requiring chemical reaction, it is possible to simplify or shorten the process of water repellent treatment using the water repellent agent.

The water repellent agent according to the present embodiment can be prepared by mixing of the components. For the mixing, ultrasonic dispersion may be used so that silica particles as the component A may be sufficiently dispersed and the resin components as the components B and C may sufficiently be dispersed or dissolved in the organic solvent as the component D. A water repellent agent may desirably be prepared in a state having fluidity such as in the state of a liquid, an emulsion, or a gel so as to be applied in the form of a film to a target surface by coating or the like.

### <Water-Repellent Treated Material>

A water-repellent treated material according to an embodiment of the present disclosure is explained hereunder. As shown in FIG. 1, a water-repellent treated material 1 according to the present embodiment contains a base material 11 and a water repellent layer 12. Water repellency is given to a surface of the base material 11 by the water repellent layer 12.

The base material 11 is made of an inorganic material or an organic material and constitutes a member to be subjected to water repellent treatment such as a connector that will be explained in the next section. The surface of the base material 11 constitutes a target surface 11a. Examples of the inorganic material constituting the base material 11 include a metal material, a semiconductor material such as silicon, and an inorganic compound such as a ceramic material or glass. Examples of the organic material include various resin materials such as a plastic and a fiber material such as cellulose.

The water repellent layer 12 covers the target surface 11a of the base material 11. The water repellent layer 12 is a layer formed through application of the water repellent agent according to the embodiment of the present disclosure explained above. The organic solvent as the component D has been evaporated from the water repellent layer 12 and the water repellent layer 12 substantially includes the components A to C and other optionally added solid components. In other words, the water repellent layer 12 covers the target surface 11a as a solid-state film. A part of the component D, however, may remain in the water repellent layer 12. Chemical structures and a blend ratio of the constituent components in the water repellent agent substantially do not change and are retained also in the water repellent layer 12, except the evaporation of the component D.

The water repellent agent is applied to the target surface 11a by painting, immersion, spraying, flowing down, printing using a printing machine such as gravure, application by various coaters such as a bar coater, a blade coater, a roll coater, an air knife coater, a screen coater, and a curtain coater, and impregnation processing with an impregnation machine. Further, drying is desirably conducted in order to evaporate the organic solvent after the water repellent agent is applied to the target surface 11a. The drying can be done by natural drying. When it is desired to reduce the time to form the film, with the aim, for example, of avoiding loss of the components in the water repellent agent applied to the target surface 11a the drying may be conducted by hot air drying or the like.

In the formed water repellent layer 12, silica particles 13 as the component A are dispersed in a resin film 14 in which the component B and the component C, which are resin components, are mixed. At a surface of the water repellent layer 12, fine roughness is formed due to particle shapes of the silica particles 13. By the existence of such a rough structure, a contact angle of water at the surface of the water repellent layer 12 increases. As a result, the surface of the water repellent layer 12 exhibits high water repellency. From the viewpoint of forming a sufficient height difference in the rough structure, it is desirable that the silica particles 13 in the water repellent layer 12 protrude outside the resin film 14 formed of the resin components (i.e., to the side opposite to the base material 11). For that purpose, a particle size and a blend ratio (A:(B+C)) of the silica particles to the component B and the component C may be selected so that an average particle size of the silica particles 13 may be larger than an average thickness of the resin film 14, for example.

The water repellent layer 12 has high thermal resistance by containing the component B having a high glass transition temperature as a resin component. That is, even when the water repellent layer 12 is heated, by containing the component B, the water repellent layer 12 hardly deforms by softening. Thus, the structure of the water repellent layer 12 or, in other words, the state where the silica particles 13 are dispersed and fixed in the water repellent layer 12 and roughness is formed at the surface of the water repellent layer 12, is held stably. Even at a high temperature, therefore, the state where the water repellent layer 12 exhibits high water repellency is stably retained.

Further, since the water repellent layer 12 contains the component C including an acid-modified resin as a resin component, the adhesiveness of the water repellent layer 12 to the target surface 11a and the fixing strength of the silica particles 13 as the component A are increased. Therefore, even when the water repellent layer 12 receives a mechanical load such as friction, peeling-off of the water repellent layer 12 or falling-off of the component A from the base material 11 is suppressed, and the state where the target surface 11a is covered with the water repellent layer 12 showing high water repellency is retained stably. The adhesiveness by the component C is exhibited to the target surface 11a made of various materials. Even when the target surface 11a of the base material 11 is made of an inorganic material such as a metal or an organic material such as a resin material, a water repellent layer 12 exhibits high adhesiveness by containing the component C.

Further, the resin components constituting the component B and the component C in the water repellent layer 12 are contained in the water repellent agent applied to the target surface 11a in the state of a polymer already formed through a polymerization reaction, but are not formed into a polymer by a chemical reaction such as polymerization on the target surface 11a as disclosed in Patent Literatures 6 to 10. Since the already formed polymer is contained in the water repellent agent in the state of being dispersed or dissolved in the organic solvent and applied to the target surface 11a, it is possible to easily form a water repellent layer 12 having a solid film structure only by removing the organic solvent, for example, by evaporation without a chemical reaction.

In this way, the water repellent layer 12 according to the present embodiment formed of a water repellent agent containing the components A to D can be formed easily. The water repellent layer 12 thus formed is excellent in water repellency, thermal resistance, and adhesiveness. It is unnecessary to use a material containing fluorine atoms for improving water repellency or an alkoxysilane for firmly adhering the silica particles 13.

A degree of water repellency of the water repellent layer 12 can be evaluated by dripping a water droplet onto the surface of the water repellent layer 12 and measuring a contact angle. If the water contact angle on the surface of the water repellent layer 12 is 100° or larger and further 125° or larger, the water repellent layer 12 can be regarded as having high water repellency. Further, if a water contact angle of those values or larger is retained even after the water repellent layer 12 is subjected to a high temperature environment of 100° C. or higher, the water repellent layer 12 can be regarded as having high thermal resistance and being able to retain high water repellency even after subjected to a high temperature environment.

### <Electrical Connection Structure>

An electrical connection structure according to an embodiment of the present disclosure is explained hereunder. An electrical connection structure according to the present embodiment is a member that can form electrical connection with another electrical connection member. The electrical connection structure contains the water-repellent treated material 1 according to the embodiment of the present disclosure explained above as a part or the whole of the electrical connection structure. In other words, a water repellent layer 12 is formed in a partial or entire region of the surface of the base material 11 constituting the electrical connection structure. Here, the surface of a base material 11 indicates generally a surface constituting a part of the electrical connection structure, including not only an external surface exposed outside the shape of the entire electrical connection structure but also an internal surface exposed inside the electrical connection structure like an internal surface 43 of a connector housing 4 of a connector 2 that will be explained next.

Since the electrical connection structure has the water repellent layer 12 on the surface 11a of the base material 11, even when water (or an electrolyte; the same applies hereinafter) comes into contact with the surface, the water hardly spreads on the surface and hardly remains covering the surface for a long period of time. The water therefore hardly stays on the external or internal surface of the electrical connection structure, or in a space surrounded by the internal surface. As a result, the water is less likely to affect the electrical connection structure such as through corrosion of a metal member.

As an example of an electrical connection structure according to the present embodiment, a connector 2 is explained briefly in reference to FIG. 2. A connector 2 has a connecting terminal 3 and a connector housing 4. The connecting terminal 3 is accommodated in the connector housing 4. The entire surface of the connecting terminal 3 is made of a metal material and can form electrical connection with a male terminal (not shown in the figure) as a mating terminal. Typically, the connecting terminal 3 is made of a tin-coated copper alloy. The entire surface of the connector housing 4 is made of a resin material. Typically, the connector housing 4 is made of a resin material containing a polyester such as polybutylene terephthalate (PBT) or a polyamide such as nylon 6.

The connecting terminal 3 is formed as a fitting-type female terminal and has a fitting part 31 in front that can form electrical connection by mating with a male terminal, which is a mating terminal. Further, the connecting terminal 3 has a barrel part 32 behind the fitting part 31. The barrel part 32 is joined through crimping to an insulated wire 9 with a conductor 92 exposed from an insulation coating 91 at an end of the wire 9. The connector housing 4 has a hollow tubular structure and has a cavity 41 that can accommodate the connecting terminal 3 inside. The connecting terminal 3 to which the insulated wire 9 is connected is accommodated in the cavity 41 of the connector housing 4.

The entire connector housing 4 is configured as a water-repellent treated material 1 according to the embodiment described above. The water repellent layer 12 formed of the water repellent agent according to the embodiment described above covers an external surface 42 and an internal surface 43 of the connector housing 4. In other words, the water repellent layer 12 covers both a surface exposed outside the connector housing 4 and a surface of the material constituting the connector housing 4 facing the cavity 41. As shown in FIG. 2, in the structure where the connecting terminal 3 to which the insulated wire 9 is connected is inserted in the connector housing 4, there is a route through which water can enter the cavity 41 of the connector housing 4. That is, water can intrude into the cavity 41 from an opening 44 formed at the front end of the connector housing 4 to insert a male terminal therethrough and from a gap 45 existing at the rear end of the connector housing 4 around the insulated wire 9. The gap 45 at the rear end can be closed with a waterproof rubber stopper or the like and water can be prevented from intruding. Meanwhile, the opening 44 at the front end, however, must be kept open for insertion of a male terminal, and it is difficult to completely close a water entry route to the cavity 41. Thus, there is a possibility that water intrudes into the cavity 41 of the connector housing 4. However, since a water repellent layer 12 covers the internal surface 43 of the connector housing 4 surrounding the cavity 41, water intruding into the cavity 41 can not remain in contact with the internal surface 43 of the connector housing 4 or stay inside the cavity 41 for a long period of time. Therefore, water hardly stays in the cavity 41 or adheres to the connecting terminal 3 accommodated in the cavity 41, whereby the electrical connection characteristics of the connector 2 is less likely affected by water such as through corrosion of a metal material constituting the connecting terminal 3. Thus, even once the connector 2 comes into contact with water, a highly reliable electrical connection structure can be retained by preventing the water from staying in the connector 2 for a long period of time.

As described above, by forming the water repellent layer 12 showing high water repellency on the surface of the connector housing 4 constituting the connector 2, it is possible to reduce the influence of adhesion or intrusion of water to the connector housing 4. Since the water repellent agent according to the embodiment described above shows high adhesiveness and water repellency on a surface of not only a resin material such as of the connector housing 4 but also a metal material, the water repellent layer 12 may be formed on the surface of the connecting terminal 3, instead of or in addition to the surface of the connector housing 4, with the water repellent agent according to the embodiment described above. In this case, the influence on electrical connection characteristics of the connection terminal 3 caused by adhesion of water to the terminal 3 is reduced.

Although explanations have been made for a fitting-type female connector 2 as an example of a connector here, the type of the connector is not limited to this. Other examples of the connector include a connector for a printed circuit board that will be used in Example presented later. A connector for a printed circuit board contains a plurality of pins as connecting terminals. The pins are inserted into pin insertion holes formed on a connector housing. It is desirable that a water repellent layer 12 covers the surface of the connector housing including the internal surfaces of the pin insertion holes. In addition, a water repellent layer 12 may also cover the surfaces of the pins. Further, the electrical connection structure according to the embodiment of the present disclosure is not limited to a connector, and it is possible to give water repellency to various constituent components of an electrical connection member such as parts of a wire harness by forming a water repellent layer 12 on the surfaces of the constituent components.

### <Wire Harness>

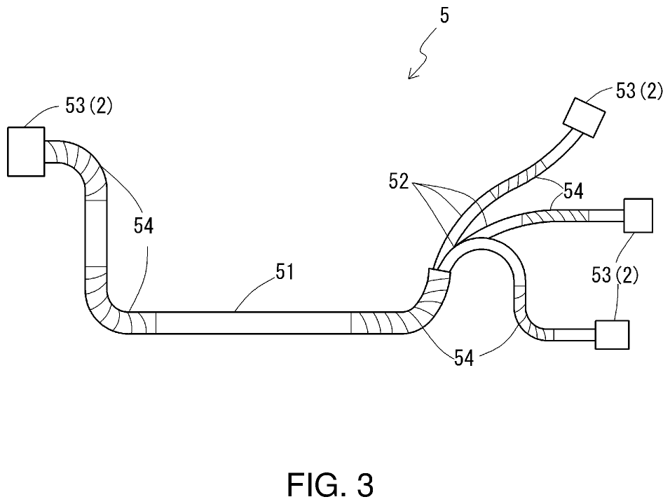

Finally, a wire harness according to an embodiment of the present disclosure is explained. A wire harness according to the present embodiment has the electrical connection structure according to the embodiment described above. As an example, a wire harness having a connector as the electrical connection structure at an end of an insulated wire is explained in reference to FIG. 3.

A wire harness contains a connector as an electrical connection structure according to the embodiment of the present disclosure such as the connector 2 explained above in the form of a terminal-fitted electrical wire where the connector is connected at least to an end of an insulated wire. The wire harness may include a plurality of terminal-fitted electrical wires. In this case, all of the terminal-fitted electrical wires constituting the wire harness may have connectors according to the embodiment of the present disclosure, or only some of the terminal-fitted electrical wires may have connectors according to the embodiment of the present disclosure.

A wire harness 5 shown in FIG. 3 includes a plurality of terminal-fitted electrical wires. The wire harness 5 has a main harness part 51 and three branch harness parts 52 branching from an end of the main harness part 51. The multiple terminal-fitted electrical wires are bundled at the main harness part 51. Those terminal-fitted electrical wires are divided into three groups and the respective groups are bundled in the respective branch harness parts 52. The multiple terminal-fitted electrical wires are bundled with an adhesive tape 54 and retain bent shapes at the main harness part 51 and the branch harness parts 52. Connectors 53 are formed at a base end part of the main harness part 51 and front end parts of the respective branch harness parts 52.

Here, at least some of the multiple connectors 53 existing on the terminal ends of the multiple terminal-fitted electrical wires constituting the wire harness 5 are the connectors 2, which are the electrical connection structures according to the embodiment of the present disclosure described above. In the wire harness, metal materials are covered with resin materials and do not come into contact with water in most of the constituent components such as the insulated wires. At an end part having an electrical connection structure such as a connector, there may exist a structure allowing water to intrude such an opening 44 of a connector housing due to the need to be connected with another conductive member such as a mating connector. Even in such a structure, however, if water repellent treatment is applied to a base material constituting an electrical connection structure with the water repellent agent according to the embodiment of the present disclosure described above, water is less likely to stay on the surface or inside the electrical connection structure, even if the electrical connection structure comes into contact with water, whereby the influence of water on electrical connection can be reduced.

In the case of a wire harness used for a vehicle such as an automobile, there is a possibility that water comes into contact with or near an electrical connection structure such as a connector at an end part. Water repellent treatment applied to the electrical connection structure can protect the electrical connection structure from the influence of the water. Further, in a wire harness used for a vehicle such as an automobile, since an electrical connection structure is likely to be exposed to a high temperature and since long-lasting water repellency is important, it is also advantageous that the water repellent layer has high thermal resistance and adhesiveness.

### Examples

Examples are shown hereunder. Here, the characteristics of the formed water repellent layer are evaluated while the component composition of the water repellent agent is changed. Meanwhile, the present invention is not limited by the examples. The samples were prepared and evaluated hereunder at room temperature in the atmosphere unless otherwise specified.

### [Test Method]

### (1) Preparation of Water Repellent Agent

First, water repellent agents of samples 1 to 19 and samples 31 to 42 are prepared through mixing of respective components in accordance with the component compositions shown in Table 1 and Table 2. For the mixing, ultrasonic dispersion is applied at room temperature for one hour and successively stirring is applied with astir bar at room temperature for 15 hours. No components other than the components shown in Tables 1 and 2 are added to the water repellent agents.

The materials used for the sample preparation are as follows.

### (Component A)

H2000: silica particles (average particle size: 12 nm) treated with methylchlorosilane; “WACKER HDK H2000” made by Wacker Asahikasei Silicone Co., Ltd.

H3004: silica particles (average particle size: 10 nm) treated with methylchlorosilane; “WACKER HDK H3004” made by Wacker Asahikasei Silicone Co., Ltd.

R805: silica particles (average particle size: 12 nm) treated with octyl group surface treatment agent; “AEROSIL R805” made by NIPPON AEROSIL CO., LTD.

R974: silica particles (average particle size: 12 nm) treated with dimethylsilyl group surface treatment agent; “AEROSIL R974” made by NIPPON AEROSIL CO., LTD.

RX200: silica particles (average particle size: 12 nm) treated with trimethylsilyl group surface treatment agent; “AEROSIL RX200” made by NIPPON AEROSIL CO., LTD.

SX110: silica particles (average particle size: 110 nm) treated with trimethylsilyl group surface treatment agent; “AEROSIL SX110” made by NIPPON AEROSIL CO., LTD.

A-200: silica particles (average particle size: 20 nm) without hydrophobic treatment; “AEROSIL 200” made by NIPPON AEROSIL CO., LTD.

TP120: silicone resin particles (average particle size: 2,000 nm); “Tospearl 120” made by MOMENTIVE Co.

D1000: talc particles (average particle size: 1,000 nm); “NANO ACE D-1000” made by NIPPON TALC CO., LTD. (Component B)

PMMA: methyl methacrylate polymer (Tg=101° C.); made by Wako Pure Chemical Industries, Ltd.

PC: polycarbonate (Tg=135° C.); “Iupilon 53000” made by Mitsubishi Engineering-Plastics Corporation

PS: polystyrene (Tg=100° C.); made by Sigma-Aldrich Co. LLC.

SEBS: hydrogenated styrene elastomer SEBS (Tg=18° C.); “S.O.E. 51605” made by ASAHI KASEI CORPORATION

PVC: polyvinyl chloride (degree of polymerization 1,000) (Tg=85° C.); made by TAIYO VINYL CORPORATION (Component C)

MAH-SBS: maleic acid-modified SEBS (Tg=15° C.); “Tufprene 912” made by ASAHI KASEI CORPORATION

MAH-SEBS: maleic acid-modified SEBS (Tg=18° C.); “Tuftec M1911” made by ASAHI KASEI CORPORATION

MAH-PE: maleic acid-modified polyethylene (Tg=−110° C.); made by Sigma-Aldrich Co. LLC.

MAH-PS: maleic acid-modified polystyrene (Tg=100° C.); made by Sigma-Aldrich Co. LLC.

### (Component D)

tetrahydrofuran (THF), butyl acetate, and toluene (all of them are made by Wako Pure Chemical Industries, Ltd., reagent first class)

### (2) Evaluation of Characteristics

### (2-1) Water Contact Angle Measurement

Flat polyamide plates having a size of 30 mm×30 mm×0.5 mm thick were immersed in the sample liquids shown in Tables 1 and 2 with the plate surfaces upright, respectively, and left for 10 seconds at room temperature. Then the plates were pulled up. Then, while dropping excess sample liquids, air dry was applied at room temperature for one hour to obtain initial-state samples for contact angle measurement. Further, samples formed in the same way as described above by being immersed into the sample liquids and dried were left in a condition of a thermal resistance test, that is, in an oven at 100° C. for 96 hours, and then were taken out to prepare post-thermal samples for contact angle measurement. Here, the condition of the thermal resistance test was in accordance with JIS C60068-2-2.

The water contact angles of the surfaces of the initial-state samples and post-thermal samples were measured. The measurements were performed with a contact angle meter (“DropMaster DM700” made by Kyowa Interface Science Co., Ltd.) in accordance with JIS R3257. For the measurement, a drop volume was set to 2 μL, and a contact angle on a sample surface was measured three seconds after the dropping. Initial and post-thermal water contact angles were recorded respectively. A larger water contact angle indicates higher water repellency on the surface of a water repellent layer.

### (2-2) Water Repellency Test

A connector housing for a printed circuit board “VH series Housing” (made of nylon 6), made by Japan Solderless Terminal Mfg. Co., Ltd. was prepared as a connector housing to be the base material of a water repellent target. This connector housing has pin insertion holes into which pins as connecting terminals are inserted. The connector housing was immersed into each of the sample liquids having the component compositions in Tables 1 and 2 at room temperature while the connector housing was placed so that the pin insertion holes were directed toward the vertical direction. Air bubbles inside the pin insertion holes were removed by lightly jiggling the connector housing in each of the sample liquids, and the connector housing was pulled up right away. Further, the connector housing was dried for one hour while passing wind into the inside of the pin insertion holes to drop the excess liquid by a dryer at room temperature with the connector housing placed in the same direction as during the immersion. Thus, an initial-state sample for water repellency test was prepared. Further, a sample formed in the same way as described above through the immersion of a connector housing into a sample liquid and the drying was left in the condition for the thermal resistance test, that is, in an oven of 100° C. for 96 hours, then was taken out to prepare a post-thermal sample for water repellency test. Here, the condition for the thermal resistance test was in accordance with JIS C60068-2-2.

For the initial-state samples and the post-thermal samples formed as described above, the mass of each of the test samples was measured. Then, each of the test samples was immersed in pure water at room temperature in the state where the connector housing was placed so that the pin insertion holes were directed toward the vertical direction. Then, air bubbles inside the pin insertion holes were removed by water flow by a pipette. Then, the sample was pulled up immediately, and the mass was measured again.

The masses of the sample before and after the immersion in pure water were compared. When the mass after immersion increased by 1% or more from the mass before immersion, it was judged that pure water remained because sufficient water repellency was not given to the surface of the connector housing including the interior of the pin insertion holes, and the water repellency was assessed as insufficient (B). In contrast, when the increase of the mass after immersion was less than 1% from the mass before immersion, it was judged that sufficient water repellency was given to the surface of the connector housing including the interior of the pin insertion holes and that the amount of pure water remaining in the hole was sufficiently small, and the water repellency was assessed as sufficient (A).

Further, in order to evaluate persistence of water repellency of a water repellent layer after heat resistance test, water repellency persistence test was performed. Specifically, samples were prepared in the same way as the post-thermal samples for water repellency test. A water flow load was applied to each of the samples for five minutes by tap water fed through the pin insertion holes at a flow rate of 1 L per minute. Successively, the mass of the sample was measured immediately. The masses before and after the water flow load was applied were compared. When the mass after the water flow load was applied increased by 1% or more from the mass before the application, it was judged that the water repellency was deteriorated by the water flow load, and the water repellency persistence after thermal resistance test was assessed as poor (B). In contrast, when the increase of the mass after the water flow load was applied was less than 1% from the mass before the application, it was judged that the water repellency was retained even after the water flow load was applied, and the water repellency persistence after thermal resistance test was assessed as excellent (A).

### (2-3) Adhesion Strength Test

Samples were prepared for adhesion strength test in the same way as the initial-state samples for water repellency test. Connecting terminals were inserted into and then removed from pin insertion holes on the connector housing of the samples. After one, two, or five repetition cycles of the insertion and removal of the terminals, the samples were immersed into pure water in the same way as in the water repellency test. Then, the masses before and after pure water immersion were compared. When the mass after immersion increased by 1% or more from the mass before immersion, it was judged that a water repellent layer had peeled off after insertion and removal of the terminals. In contrast, when the increase of the mass after immersion was less than 1% from the mass before immersion, it was judged that a water repellent layer had not peeled off even after insertion and removal of the terminals. When peeling-off of the water repellent layer was observed after one cycle of insertion and removal of the terminals, the sample was assessed as having insufficient adhesion strength (B). In contrast, when peeling-off of the water repellent layer was not observed even after one cycle of insertion and removal of the terminals, the sample was assessed as having sufficient adhesion strength (A). Further, when peeling-off of the water repellent layer was not observed even after two repetition cycles of insertion and removal of the terminals, the sample was assessed as having excellent adhesion strength (A+). Moreover, when peeling-off of the water repellent layer was not observed even after five repetition cycles of insertion and removal of the terminals, the sample was assessed as having particularly excellent adhesion strength (A++).

### [Test Results]

The component compositions of the water repellent agents of the samples 1 to 19 and the samples 31 to 42 and the results of the respective evaluation tests are shown in Tables 1 and 2 below. With regard to the component compositions, amounts of the components are described in parts by mass.

TABLE 1

| | | Average | | | | | | | | | | | | |
|---|---|---|---|---|---|---|---|---|---|---|---|---|---|---|
| | | diameter | Tg | Samples | | | | | | | | | | |
| | | (nm) | (° C.) | 1 | 2 | 3 | 4 | 5 | 6 | 7 | 8 | 9 | 10 | 11 |
| Com- | H2000 | 12 | | 5 | | | | | 5 | 5 | 5 | 5 | 5 | 5 |
| ponent | H3004 | 10 | | | 5 | | | | | | | | | |
| A | R805 | 12 | | | | 5 | | | | | | | | |
| | R974 | 12 | | | | | 5 | | | | | | | |
| | RX200 | 12 | | | | | | 5 | | | | | | |
| | SX110 | 110 | | | | | | | | | | | | |
| | A-200 | 20 | | | | | | | | | | | | |
| | TP120 | 20 | | | | | | | | | | | | |
| | D1000 | 1000 | | | | | | | | | | | | |
| Com- | PMMA | | 101 | 5 | 5 | 5 | 5 | 5 | | | 5 | 5 | 5 | 5 |
| ponent | PC | | 135 | | | | | | 5 | | | | | |
| B | PS | | 100 | | | | | | | 5 | | | | |
| | SEBS | | 18 | | | | | | | | | | | |
| | PVC | | 85 | | | | | | | | | | | |
| Com- | MAH- | | 15 | 0.5 | 0.5 | 0.5 | 0.5 | 0.5 | 0.5 | 0.5 | | | | 0.5 |
| ponent | SBS | | | | | | | | | | | | | |
| C | MAH- | | 18 | | | | | | | | 0.5 | | | |
| | SEBS | | | | | | | | | | | | | |
| | MAH- | | −110 | | | | | | | | | 0.5 | | |
| | PE | | | | | | | | | | | | | |
| | MAH- | | 100 | | | | | | | | | | 0.5 | |
| | PS | | | | | | | | | | | | | |
| Com- | THF | | | 89.5 | 89.5 | 89.5 | 89.5 | 89.5 | 89.5 | 89.5 | 89.5 | | 89.5 | |
| ponent | Butyl | | | | | | | | | | | | | 89.5 |
| D | acetate | | | | | | | | | | | | | |
| | Toluene | | | | | | | | | | | 89.5 | | |

| | | | | | | | | | | | | |
|---|---|---|---|---|---|---|---|---|---|---|---|---|
| Water | Initial state | 137 | 135 | 139 | 135 | 138 | 142 | 142 | 139 | 141 | 138 | 138 |
| contact | After thermal | 135 | 135 | 139 | 134 | 138 | 140 | 140 | 139 | 141 | 135 | 138 |
| angle(°) | resistance test | | | | | | | | | | | |
| Water | Initial state | A | A | A | A | A | A | A | A | A | A | A |
| repellency | After thermal | A | A | A | A | A | A | A | A | A | A | A |
| | resistance test | | | | | | | | | | | |
| | Water repellency | A | A | A | A | A | A | A | A | A | A | A |
| | persistence (after | | | | | | | | | | | |
| | thermal resistance test) | | | | | | | | | | | |

| | | | | | | | | | | | |
|---|---|---|---|---|---|---|---|---|---|---|---|
| Adhesion strength | A++ | A++ | A++ | A++ | A++ | A++ | A++ | A++ | A++ | A++ | A++ |

| | | Average | | | | | | | | | |
|---|---|---|---|---|---|---|---|---|---|---|---|
| | | diameter | Tg | Samples | | | | | | | |
| | | (nm) | (° C.) | 12 | 13 | 14 | 15 | 16 | 17 | 18 | 19 |
| Com- | H2000 | 12 | | 5 | 0.08 | 12 | 9.2 | 2.5 | 5 | 5 | |
| ponent | H3004 | 10 | | | | | | | | | |
| A | R805 | 12 | | | | | | | | | |
| | R974 | 12 | | | | | | | | | |
| | RX200 | 12 | | | | | | | | | |
| | SX110 | 110 | | | | | | | | | 5 |
| | A-200 | 20 | | | | | | | | | |
| | TP120 | 20 | | | | | | | | | |
| | D1000 | 1000 | | | | | | | | | |
| Com- | PMMA | | 101 | 5 | 0.12 | 8 | 0.8 | 7.5 | 2.5 | 5 | 5 |
| ponent | PC | | 135 | | | | | | | | |
| B | PS | | 100 | | | | | | | | |
| | SEBS | | 18 | | | | | | | | |
| | PVC | | 85 | | | | | | | | |
| Com- | MAH- | | 15 | 0.5 | 0.01 | 0.8 | 0.08 | 0.75 | 2.5 | 0.25 | 0.5 |
| ponent | SBS | | | | | | | | | | |
| C | MAH- | | 18 | | | | | | | | |
| | SEBS | | | | | | | | | | |
| | MAH- | | −110 | | | | | | | | |
| | PE | | | | | | | | | | |
| | MAH- | | 100 | | | | | | | | |
| | PS | | | | | | | | | | |
| Com- | THF | | | | 99.8 | 79.2 | 89.9 | 89.2 | 90 | 89.7 | 89.5 |
| ponent | Butyl acetate | | | | | | | | | | |
| D | Toluene | | | 89.5 | | | | | | | |

| | | | | | | | | | |
|---|---|---|---|---|---|---|---|---|---|
| Water | Initial state | 136 | 130 | 131 | 136 | 129 | 134 | 135 | 128 |
| contact | After thermal | 136 | 130 | 131 | 133 | 129 | 128 | 133 | 129 |
| angle(°) | resistance test | | | | | | | | |
| Water | Initial state | A | A | A | A | A | A | A | A |
| repellency | After thermal | A | A | A | A | A | A | A | A |
| | resistance test | | | | | | | | |
| | Water repellency | A | A | A | A | A | A | A | A |
| | persistance (after | | | | | | | | |
| | thermal resistance test) | | | | | | | | |

| | | | | | | | | |
|---|---|---|---|---|---|---|---|---|
| Adhesion strength | A++ | A++ | A++ | A++ | A++ | A++ | A++ | A++ |

TABLE 2

| | | Average | | | | | | | | | | | | | |
|---|---|---|---|---|---|---|---|---|---|---|---|---|---|---|---|
| | | diameter | | Samples | | | | | | | | | | | |
| | | (nm) | Tg (° C.) | 31 | 32 | 33 | 34 | 35 | 36 | 37 | 38 | 39 | 40 | 41 | 42 |
| Component | H2000 | 12 | | | | | | 10 | 5 | 5 | 5 | 5 | 5 | 5 | 5 |
| A | H3004 | 10 | | | | | | | | | | | | | |
| | R805 | 12 | | | | | | | | | | | | | |
| | R974 | 12 | | | | | | | | | | | | | |
| | RX200 | 12 | | | | | | | | | | | | | |
| | SX110 | 110 | | | | | | | | | | | | | |
| | A-200 | 20 | | | 5 | | | | | | | | | | |
| | TP120 | 2000 | | | | 5 | | | | | | | | | |
| | D1000 | 1000 | | | | | 5 | | | | | | | | |
| Component | PMMA | | 101 | 10 | 5 | 5 | 5 | | | | 2 | 5 | | 5 | 5 |
| B | PC | | 135 | | | | | | | | | | | | |
| | PS | | 100 | | | | | | | | | | | | |
| | SEBS | | 18 | | | | | | 5 | | | | 5 | 0.5 | |
| | PVC | | 85 | | | | | | | 5 | | | | | |
| Component | MAH-SBS | | 15 | 1 | 0.5 | 0.5 | 0.5 | 1 | 0.5 | 0.5 | 3 | | | | 0.2 |
| C | MAH-SEBS | | 18 | | | | | | | | | | | | |
| | MAH-PE | | −110 | | | | | | | | | | | | |
| | MAH-PS | | 100 | | | | | | | | | | | | |
| Component | THF | | | 89 | 89.5 | 89.5 | 89.5 | 89 | 89.5 | 89.5 | 90 | 90 | 90 | 89.5 | 89.8 |
| D | Butyl acetate | | | | | | | | | | | | | | |
| | Toluene | | | | | | | | | | | | | | |

| | | | | | | | | | | | | | |
|---|---|---|---|---|---|---|---|---|---|---|---|---|---|
| Water | Initial state | 71 | 68 | 108 | 70 | 136 | 135 | 132 | 131 | 138 | 134 | 139 | 135 |
| contact | After thermal resistance test | 69 | 66 | 105 | 71 | 129 | 87 | 92 | 90 | 136 | 89 | 127 | 131 |
| angle(°) | | | | | | | | | | | | | |
| Water | Initial state | B | B | B | B | A | A | A | A | A | A | A | A |
| repellency | After thermal resistance test | B | B | B | B | A | B | B | B | A | B | A | A |
| | Water repellency persistance | B | B | B | B | B | B | B | B | A | B | A | A |
| | (after thermal resistance test) | | | | | | | | | | | | |

| | | | | | | | | | | | | |
|---|---|---|---|---|---|---|---|---|---|---|---|---|
| Adhesion strength | B | B | B | B | B | B | B | B | B | B | B | B |

As shown in Table 1, with respect to the samples 1 to 19, the water repellent agents each contained hydrophobized silica particles as the component A, and further contained a resin having a glass transition temperature of 100° C. or higher as the component B and an acid-modified resin as the component C as the resin components at a mass ratio B:C in the range of 95:5 to 50:50. Corresponding to the compositions, the formed water repellent layers had high water repellency. That is, large water contact angles of 125° or larger were observed, and sufficient water repellency was confirmed in the water repellency test. Further, after the thermal resistance test, large water contact angles and sufficient water repellency were observed. Furthermore the water repellency persistence after the thermal resistance test was excellent. This result indicates that the water repellent layers had high thermal resistance. Moreover, the water repellent layers of the samples 1 to 19 exhibited, in the adhesion strength test, sufficient adhesion strength.

In contrast, as shown in Table 2, with respect to the samples 31 to 42, some of the components A to C consisting of the specific substances described above were not contained or the content ratio of the components B and C deviated from the above-specified range. Thus, the samples did not show the sufficient water repellency, thermal resistance, and adhesiveness all at the same time. Specifically, the sample 31 did not contain hydrophobized silica particles as component A while the sample 32 contained silica particles but the silica particles were not hydrophobized. In the samples 33 and 34, the particles contained as the component A were not silica particles. In each of the samples, not containing hydrophobized silica particles, only a small water contact angle of 125° or smaller was obtained even in the initial state before the thermal resistance test or physical load application. Further, in the water repellency test, the result of insufficient water repellency was observed.

As for each of the samples 35 to 42, because the water repellent agent contained hydrophobized silica particles, a large water contact angle and a good water repellency test result were obtained in the initial state before the thermal resistance test or physical load application by insertion and removal of the terminals. But, since the resin component mixed with the silica particles did not have the specific composition, the water repellency deteriorated after the thermal resistance test and/or physical load application. First, in the sample 35, the component B as a resin component was not contained, and only a small amount of MAH-SBS was contained as the component C. For the sample, the water contact angle decreased after the thermal resistance test, and the water repellency persistence evaluated in the water repellency test after thermal resistance test deteriorated. In the adhesion strength test, insufficient adhesiveness was observed. These result mean that the hydrophobized silica particles can not be attached firmly to the surface of the base material and that the thermal resistance and adhesiveness of the water repellent layer deteriorated because the sample 35 did not contain the component B having a high glass transition temperature but contained only a small amount of the resin having a low glass transition temperature classified as the component C as the resin component.

In each of the samples 36 and 37, a resin having a glass transition temperature of lower than 100° C. was used as the component B. In each of the samples, the water contact angle decreased, and the water repellency deteriorated after the thermal resistance test. On the adhesion strength test, insufficient adhesiveness was observed. It can be deduced that the thermal resistance of the water repellent layer decreased because the glass transition temperature of the component B was low. The decrease in adhesiveness shown in the adhesiveness test can be interpreted as decrease in mechanical strength of the water repellent layer due to the low glass transition temperature of the component B. In the sample 38, although a material having a glass transition temperature of 100° C. or higher was contained as the component B, the amount of the component B was smaller than the amount expressed by the mass ratio B:C of 50:50. For the sample 38, the water contact angle decreased, and the water repellency deteriorated after the thermal resistance test. Further, insufficient adhesiveness was observed in the adhesion strength test. These results mean that the water repellent layer did not have sufficient thermal resistance and the film structure dispersing and fixing the silica particles was not retained sufficiently under a high temperature because the content of the component B that has a high glass transition temperature and can give thermal resistance to the water repellent layer was too low. The low adhesiveness observed in the adhesiveness test means that the mechanical strength of the water repellent layer deteriorated because the amount of the component C was too large in comparison with the component B and hence the effect brought about by the glass transition temperature of the component B was not exhibited enough.

In the sample 39, the component C was not contained in the water repellent agent, and only the component B having a glass transition temperature of 100° C. or higher was contained as the resin component. For the sample 39, a large water contact angle and high water repellency were observed, and the water repellency persistence was high even after the thermal resistance test. However, in the adhesion strength test, the water repellency deteriorated after the physical load was applied by insertion and removal of the terminals. These results mean that the water repellent layer having adhesiveness withstanding frictional force generated by insertion and removal of the terminals was not formed because the water repellent agent did not contain the component C that consists of an acid-modified resin and contributes to the improvement of the adhesiveness of the water repellent layer to the base material. In the sample 40, the component C was not contained in the water repellent agent and the resin component included only SEBS, which has a low glass transition temperature of lower than 100° C. When this sample was tested, the water contact angle decreased, and the water repellency deteriorated after the thermal resistance test. In the adhesion strength test, insufficient adhesiveness was obtained. These results mean that the water repellent layer having high thermal resistance was not formed and the film structure dispersing and fixing the silica particles was not maintained sufficiently under a high temperature because the water repellent agent did not contain the component B having a high glass transition temperature. Further, it can be deduced that, even if a resin having a lower glass transition temperature is contained as a resin component, unless the resin is acid-modified, the resin does not function to enhance the adhesiveness of the water repellent layer instead of the component C. In the sample 41, the component C was not contained, and instead SEBS, which is an unmodified elastomer, was contained together with the component B having a glass transition temperature of 100° C. or higher. For the sample 41, similarly to the sample 39, a large water contact angle and high water repellency were obtained even after the thermal resistance test, and the water repellency persistence was also high. However, in the adhesion strength test, the water repellency deteriorated after the physical load was applied by insertion and removal of the terminals. These results show that since the resin component mixed with the component B was an elastomer but was not acid-modified, unlike the component C, the effect of enhancing the adhesiveness of the water repellent layer was not sufficiently exhibited. In the sample 42, although the component C consisting of the acid-modified resin was contained, the amount of the component C was smaller than the amount expressed by the mass ratio B:C of 95:5. Since the amount of the component C, which has the effect of enhancing the adhesiveness of a water repellent layer, is too small, the water repellency deteriorated in the adhesion strength test after the physical load was applied by insertion and removal of the terminals.

Based on comparison of the test results between the samples 1 to 19 and the samples 31 to 42, a water repellent agent containing the specific components A to C and having a content ratio of the component B and the component C in the specific range, forms a water repellent layer on a surface of the base material which has high water repellency and is excellent in thermal resistance and adhesiveness. Further, the water repellent layer can retain the high thermal resistance even after heating and application of physical load. The samples 1 to 19 respectively contained, as the acid-modified resin (component C), MAH-SBS and MAH-SEBS, which are elastomers having low glass transition temperatures, and MAH-PE and MAH-PS, which are non-elastomeric resins having high glass transition temperatures. The sample 10 contained MAH-PS in the latter group as the component C. The adhesiveness of the sample 10 was not as good as the adhesiveness of the other samples. From this, it can be deduced that it is particularly suitable to enhance the adhesiveness of the water repellent layer by using an acid-modified product of an elastomer or a resin having a low glass transition temperature such as polyolefin as an acid-modified resin (component C). Further, the samples 1 to 19 contained silica particles different in particle size (component A). The sample 19 which contained silica particles having a particle size exceeding 100 nm did not exhibit adhesion strength as high as the adhesion strength of other samples containing silica particles having particle sizes of 100 nm or smaller. These results indicate that it is suitable for enhancing the stability in fixing the silica particles to use silica particles having a particle size of 100 nm or smaller as the silica particles as the component A.

1. A water repellent agent comprising:
hydrophobized silica particles as component A;
a resin having a glass transition temperature of 100° C. or higher as component B;
an acid-modified resin as component C; and
an organic solvent as component D,
having a mass ratio B:C of the component B and the component C in the range of 95:5 to 50:50.

2. The water repellent agent according to claim 1, wherein the component C contains an acid-modified elastomer.

3. The water repellent agent according to claim 1, wherein the component C is a maleic acid-modified resin.

4. The water repellent agent according to claim 1, wherein silica particles constituting the component A has an average particle size of 100 nm or smaller.

5. The water repellent agent according to claim 1, wherein a content of the component A is 0.1% or more and 10% or less by mass.

6. The water repellent agent according to claim 1, wherein a mass ratio A:(B+C) between the component A and a sum of the component B and the component C is in the range of 90:10 to 30:70.

7. The water repellent agent according to claim 1, wherein the water repellent agent does not comprise a material containing fluorine atoms.

8. The water repellent agent according to claim 1, wherein the water repellent agent does not comprise an alkoxysilane.

9. The water repellent agent according to claim 1, wherein the organic solvent as the component D has a boiling point of 150° C. or lower.

10. A water-repellent treated material having:
a base material; and
a water repellent layer formed of the water repellent agent according to claim 1 covering a surface of the base material.

11. The water-repellent treated material according to claim 10, wherein the component D has been evaporated from the water repellent layer.

12. The water-repellent treated material according to claim 10, wherein the base material comprises a resin or metal material at the surface thereof.

13. An electrical connection structure comprising the water-repellent treated material according to claim 10, wherein the structure can form electrical connection with another electrical connection member.

14. The electrical connection structure according to claim 13, wherein the structure is configured as a connector comprising:
a connecting terminal comprising a metal material at a surface thereof; and
a connector housing accommodating the connecting terminal and comprising a resin material at a surface thereof,
the connector comprising the water repellent layer on at least one selected from the group consisting of the surface of the metal material of the connecting terminal and the surface of the resin material of the connector housing.

15. A wire harness comprising the electrical connection structure according to claim 13.
